(19) United States
(12) Patent Application Publication
(10) Pub. No.: US 2026/0365807 A1
(43) Pub. Date: Nov. 19, 2026

(54) COVER LAYER, FIBER-BASED INSULATION PRODUCT, AND PRODUCTION METHOD

(71) Applicant: JOHNS MANVILLE, Denver, CO (US)

(72) Inventor: Michael Ketzer, Collenberg (DE)

(21) Appl. No.: 19/672,178

(22) Filed: May 8, 2026

(30) Foreign Application Priority Data
May 14, 2025 (EP) 25176469..2

(51) Int. Cl. C08J 5/24; C08L 23/12; C08L 27/04; C08L 75/04

(52) U.S. Cl. CPC C08J 5/244; C08L 23/12; C08L 27/04; C08L 75/04; C08J 2323/12; C08J 2323/30; C08J 2327/06; C08J 2375/04; C08J 2429/04; C08J 2431/04; C08J 2433/04; C08L 2201/52

(57) ABSTRACT

The present disclosure relates to a cover layer and a fiber-based insulation product comprising at least one core layer, comprising insulation material, and at least one cover layer, comprising a nonwoven fiber mat, comprising mineral fibers and/or polymer fibers and a new binder composition comprising at least one polymer wax emulsion, optionally a thermoplastic emulsion, in particular the polymer wax emulsion being based on polyolefin and/or polyurethane and/or polyvinyl chloride (PVC) or polyethylene terephthalate (PET) or similar, and at least one base binder of polyvinyl alcohol or polyacrylate or polyvinyl acetate, or a combination thereof. Furthermore, the disclosure relates to a method for manufacturing a fiber-based insulation product.

### TECHNICAL FIELD

The present disclosure relates to fiber-based insulation products comprising a binder composition that is suitable for use in the manufacture of composite materials incorporating nonwoven substrates. Composite materials incorporating such binder compositions in their nonwoven components are particularly useful in the field of building insulation, especially as nonwoven fiber mats employed as facers for construction boards and insulation materials.

### BACKGROUND

Composite materials are increasingly replacing traditional building materials as construction materials and must be adapted for a wide range of applications. On one hand, sufficient mechanical stability is required and, on the other hand, good workability and low weight are necessary and sustainability and environmental considerations are increasingly important. Moreover, there is a need for adaptation to today's environmental requests and improvements. Notably, many disadvantages exist with respect to existing reinforced wooden laminates including a high amount of VOCs (Volatile Organic Compounds), a high amount of volatile formaldehyde, limited mechanical strength, and complex production. Reinforcing glass nonwovens exhibit significant brittleness creating handling problems and dust during the manufacturing process and the subsequent lamination steps. For some applications a more flexible nonwoven product is desired.

It has now been found that by using a specific binder composition for the nonwoven components, in particular for reinforcing nonwoven components, of such composite materials, the aforementioned problems can be solved, resulting in more flexible and less brittle nonwovens that reduce handling problems and dust formation during the manufacturing process and subsequent lamination steps, while also enabling a streamlined manufacturing process; furthermore, the resulting nonwoven materials are particularly suitable for use as back facers, for example in ceiling tiles comprising fibrous materials.

### SUMMARY OF THE DISCLOSURE

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a laminate composite material is provided. The laminate composite material comprises at least one cover layer and at least one nonwoven layer. The nonwoven layer comprises mineral fibers and/or polymer fibers or filaments and 1 to 45% by wt. of a thermoplastic binder composition to bond together the nonwoven web of fibers. The thermoplastic binder composition comprises at least one aqueous polymer binder and 10 to 75% by wt. of at least one polymer wax emulsion based on the total weight of the binder. The fiber nonwoven layer is pressed or laminated to the cover layer.

According to other aspects of the present disclosure, the laminate composite material may include one or more of the following features. The thermoplastic binder composition may comprise at least one aqueous polymer binder comprising a polyvinyl acetate (PVAc) and/or a polyacrylate and/or a polyvinyl alcohol (PVA) and/or a starch and/or a sugar derivative or lignin. The fiber nonwoven layer may comprise glass or polymer fibers or polymer filaments or mixture thereof. The thermoplastic binder composition may comprise 10 to 70% by wt., or 10 to 50%, or 20% to 30% by wt. of a polymer wax emulsion based on the total weight of the binder. The polymer wax emulsion may be selected from the group consisting of polypropene wax emulsions (PP wax), polyethylene wax emulsions (PE Wax), polyethylene terephthalate wax emulsions (PET Wax), polyurethane wax emulsions (PU Wax), acrylic wax emulsions and mixtures thereof. The thermoplastic binder composition may comprise 25 to 75% by wt. of a polyacrylate and/or PVAc and/or starch and/or lignin based on the total weight of the binder, or 30 to 70% by wt. The binder composition may be present in the nonwoven layer in a total amount of 10 to 80% by weight of the total fiber nonwoven layer, or 5 to 40% by wt. The cover layer may comprise a metal layer or a plastic layer or a paper layer or a cardboard layer, such as a metal foil, an aluminum foil or copper foil or a plastic layer or a plastic decor outer layer. The plastic layer or plastic decor layer may consist of PP, PA, PE, PET, PVC or combinations thereof. The fiber layer may comprise glass fibers having a mean diameter of between 6 micron and 25 micron and length between 8 mm and 30 mm or PET fibers of 2-16 micron at length of 6 mm-20 mm or PET endless filaments of 3 dtex to 15 dtex or mixtures thereof. The fiber layer may have a thickness between 0.1 mm and 10 mm, or between 0.2 mm and 0.6 mm, and an average weight of between 10 g/sqm and 300 g/sqm, or 20 g/sqm and 150 g/sqm. The nonwoven layer may comprise mineral fibers such as C-glass fibers, E-glass fibers, S-glass fibers, T-glass fibers, aluminosilicate fibers, ceramic fibers, dolomite fibers, wollastonite fibers or fibers of vulcanites, such as basalt fibers, diabase fibers, melaphyr fibers, or a combination thereof, or PET fibers or a mixture of mineral fibers and PET fibers or PET filaments. The thermoplastic binder composition may further comprise at least one additive and/or functional material, such as fire retardants, flame proofing agents, materials for discharging electrostatic charges, materials for screening off electromagnetic rays, organic or inorganic pigments, and materials that increase the resistance to wear and/or slippage.

According to another aspect of the present disclosure, a method for manufacturing a laminate composite material is provided. The method comprises providing mineral fibers in an aqueous fiber slurry in a wet laid process onto a transport belt, or providing PET fibers or mixtures of PET fibers with mineral fibers in an aqueous fiber slurry in a wet laid process onto a transport belt. The method further comprises removing the white water at least partly. The method further comprises applying a thermoplastic binder composition comprising at least one aqueous thermoplastic binder and 25 to 75% by wt. of at least one polymer wax emulsion based on the total weight of the binder. The method further comprises drying the resulting fiber nonwoven. The method further comprises laminating a cover layer to the fiber nonwoven at a temperature of between 100 Celsius to 250 Celsius at a pressure of between 1 bar and 40 bar.

According to other aspects of the present disclosure, the method may include one or more of the following features. The thermoplastic binder composition may be applied by curtain coating or sprayed on one side.

According to another aspect of the present disclosure, an insulation product is provided. The insulation product comprises a polyurethane foam core or other chemically compatible foams and at least one laminate composite material on at least one surface.

According to another aspect of the present disclosure, an insulation product is provided. The insulation product comprises a mineral wool product and a laminate composite material.

According to another aspect of the present disclosure, a laminate composite material is provided for use in gypsum panels and in interior construction, for use as facers for polyisocyanurate boards (referred to as “polyiso boards” for short), linings, floor coverings.

According to another aspect of the present disclosure, a laminate composite material is provided forming a composite board or a decorative board or decorative laminate or a building membrane.

According to another aspect of the present disclosure, a cover layer is provided. The cover layer comprises at least one nonwoven fiber mat comprising mineral fibers and/or polymer fibers and a binder composition. The binder composition comprises at least one polymer wax emulsion and at least one base binder of polyvinyl alcohol, polyacrylate, or polyvinyl acetate, or a combination thereof.

According to another aspect of the present disclosure, a fiber-based insulation product is provided. The fiber-based insulation product comprises at least one core layer comprising an insulation material and at least one cover layer forming the outermost surface. The cover layer comprises at least one nonwoven fiber mat comprising mineral fibers and/or polymer fibers and a binder composition. The binder composition comprises at least one polymer wax emulsion and at least one base binder of polyvinyl alcohol, polyacrylate, or polyvinyl acetate, or a combination thereof.

According to other aspects of the present disclosure, the fiber-based insulation product may include one or more of the following features. The binder may further comprise a carbohydrate binder component selected from monosaccharide, disaccharide, trisaccharides, tetrasacharides, pentasaccharides and/or reaction products thereof, or a combination thereof. The at least one polymer wax emulsion may be a thermoplastic emulsion. The thermoplastic emulsion may be based on polyolefin, polyurethane (PU), polyvinyl chloride (PVC), polyethylene terephthalate (PET), or a combination thereof. The polyolefin may be polypropylene (PP), polyethylene (PE), or a combination thereof. The at least one base polymer wax emulsion may be colored by black pigments. The at least one polymer wax emulsion may have a solids content of 25 to 55% by weight, or 40% by weight. The at least one base binder may have a solids content of 20 to 30% by weight, or 25% by weight. The binder composition may further comprise corrosion inhibitors, crosslinking density enhancers, biocides, or a combination thereof. The nonwoven fiber mat may comprise at least 50% of the mineral fibers and/or polymer fibers by weight. The nonwoven fiber mat may comprise glass fibers. The nonwoven fiber mat may comprise 15 to 35% of the binder composition by weight, or 28% by weight. The insulation material may comprise a polyurethane foam and/or a wool material. The core layer may be adhered to the nonwoven fiber mat by at least locally remelted binder composition.

According to another aspect of the present disclosure, a method for manufacturing a fiber-based insulation product is provided. The method comprises applying a binder composition to mineral fibers and/or polymer fibers, whereby the binder comprises at least one polymer wax emulsion and at least one base binder of polyvinyl alcohol, polyacrylate, or polyvinyl acetate, or a combination thereof. The method further comprises curing or drying of the resulting nonwoven fiber mat. The method further comprises adhering the nonwoven fiber mat to a core layer by at least locally remelting the binder composition and pressing the nonwoven fiber mat onto the core layer.

According to other aspects of the present disclosure, the method may include one or more of the following features. The binder composition may be applied by curtain coating or sprayed. The nonwoven fiber mat may be cured at a temperature of 160 to 230 °C, or 210 to 220 °C. The nonwoven fiber mat may be pressed onto the core layer at a temperature of 100 to 250 °C, or 150 to 230 °C, or 180 °C. The nonwoven fiber mat may be pressed onto the core layer using a pressure of 1 to 400 N/cm², or 50 to 200 N/cm², or 100 N/cm².

The foregoing general description of the illustrative embodiments and the following detailed description thereof are merely exemplary aspects of the teachings of this disclosure and are not restrictive.

### DETAILED DESCRIPTION

Subject matter of the present disclosure is a new binder composition comprising (i) at least one polymer wax emulsion, optionally a thermoplastic emulsion, in particular the polymer wax emulsion is based on polyolefin and/or polyurethane and/or PVC emulsions and/or PET or similar.

The above binder composition is applied to nonwoven fabrics which then can be used as semi-finished products for the production of laminates. The binder composition can also be applied during the manufacturing of the nonwoven fabric and can also be applied separately by a spray gun or bar to one side.

The term “dispersion” as used herein refers to a system consisting of several phases, one of which is continuous (dispersant) and at least one other is finely dispersed (dispersed phase, dispersant), a so called disperse system. Various forms of dispersion are e.g. emulsion, suspension, aerosol and foam.

The term “emulsion” as used herein refers to a disperse system with a liquid phase, the disperse phase, distributed in another liquid phase, the outer phase. An emulsion is a possible embodiment of a dispersion.

The term “suspension” as used herein refers to a mixture of a solid with a liquid. A suspension is another possible embodiment of a dispersion.

The laminate composite material according to the disclosure, comprises
at least one cover layer and
at least one fiber nonwoven layer, comprising mineral fibers and/or polymer fibers and 1 to 45% by wt. of a thermoplastic binder composition to bond together the nonwoven web of fibers,
characterized in that the thermoplastic binder composition comprises
   a) at least one aqueous polymer binder and
   b) 10 to 90% by wt. or 10 to 75% by wt. of at least one polymer wax emulsion based on the total weight of the binder and the fiber nonwoven layer is pressed or laminated to the cover layer.

### Binder

The new thermoplastic binder composition contains at least one so called base binder. The binder composition comprises such base binder together with at least one polymer wax emulsion, optionally a thermoplastic emulsion, in particular based upon a polyolefin emulsion, or a polyurethane based emulsion or PVC emulsions or PET or similar. The polymer wax emulsion is optionally selected from the group consisting of polypropene wax emulsions (PP wax), polyethylene wax emulsions (PE Wax), polyethylene terephthalate wax emulsions (PET Wax), polyurethane wax emulsions (PU Wax), polyacrylate wax emulsions and mixtures thereof. The polypropene wax and the polyethylene wax may be oxidized polypropene wax or oxidized poylethylene wax.

The binder composition of the present disclosure can be applied to nonwoven fabrics which can be used for the manufacturing of composite materials and laminates. The binder composition can be applied during or after the forming of the nonwoven fabric. The binder composition is applied to the non-woven structure and then partly cured. The non-woven structure comprising the binder can then be processed into composites or laminates.

The thermoplastic binder composition comprises at least one aqueous polymeric binder base binder comprising polyvinyl acetate (PVAc), polyacrylate, polyvinyl alcohol (PVA), starch, sugar derivatives, lignin or mixtures thereof, optionally comprising at least one PVAc and/or at least one polyacrylate. Base binders are aqueous polymeric binder, optionally binders based on polyvinyl emulsions, polyacrylate emulsions, aqueous polymer dispersions based on vinyl acetate and their mixtures. Such binders are usually cured at temperatures of ca. 150 °C-250 °C in one step.

The polymer wax emulsion is optionally selected from the group consisting of polyolefin wax emulsions, polypropene wax emulsions (PP wax), polyethylene wax emulsions (PE Wax), polyethylene terephthalate wax emulsions (PET Wax), polyurethane wax emulsions (PU Wax), acrylic wax emulsions and mixtures thereof.

In some embodiments, the thermoplastic binder composition comprises 25 to 90% by wt. of a polyacrylate and/or PVAc based on the total weight of the binder, optionally 30 to 75% by wt., more optionally 30 to 70% by wt., more optionally 50 to 70% by wt . . .

The binder composition may be present in the fiber nonwoven layer in a total amount of 10 to 80% by weight of the total fiber nonwoven layer, optionally 5 to 40% by wt.

Optionally, the binder composition consists essentially of at least one base binder, as described above, and at least one polymer wax emulsion, optionally a thermoplastic emulsion, in particular the polymer wax emulsion is based on polyolefin and/or polyurethane or PVC emulsions or PET emulsions or mixtures thereof. The thermoplastic polymer wax emulsion is chemically different from the base binder. Thermoplastic emulsions show a distinct 3-dimensional crosslinking compared to polyvinyl or acrylic in solution.

The polymer wax emulsion is added to the optionally aqueous base-binder before the application of the binder onto the non-woven structure.

The thermoplastic binder composition contains, at least 10% polymer wax emulsion, based on the total solid content of the binder composition, optionally up to a value of approximately 75%. The optimum value depending on the binder used. The thermoplastic binder composition comprises 10 to 70% by wt., optionally 10 to 50%, optionally 20% to 30% by wt. of the polymer wax emulsion based on the total weight of the binder.

Some polymer wax emulsions are commercially available. Examples are Byk Aquacer 1777, Byk Aquacer 1547 as well as the Addcomp products Priex 701, Priex 702 or Priex 703 (polypropylene emulsion). Other examples are PVC emulsions from Solvin NanoVin or styrene-acrylic emulsions from Lubrizol or PE emulsions from Michelman or EASTEK 1200 PET emulsion. Usually, such emulsions comprise additional components such as additives, emulsifiers, stabilizers, etc.

As discussed later the addition of the polymer wax emulsion, in particular for emulsion based on polyolefin and/or polyurethane, and/or PVC basis to the base binder induces multiple benefits and effects. Besides a higher flexibility of the nonwoven fabric and less brittleness and dust, laminates made with these nonwoven fabrics exhibit no or low VOC's, higher resistance when fire retardant additives used as second component. When using other emulsions similar effects can be observed regarding dust and brittleness. The polyolefin based polymer wax emulsion vary displays an excellent adhere to aluminum foils without using further binder saving process steps. This version also enables to connect to polyolefin based decor layers for decorative furniture end use. Variations of PVC, PET and other allow to specific lamination to chemical compatible décor layers: PET décor layers, PVC décor layers a.s.o. In combination with metal films it provides further decorative aspects.

In use as facers for polyiso boards the composite of glass fiber non-woven in combination with Aluminum thin foils offers gas tightness (keeping the pentane inside the foam cell) powering insulation performance up, increases the fire retardancy and physical improvement as impact e.g.

The above-mentioned base binders provide enough strength to generate the nonwoven out of staple fibers (binding forces) and enable processing in application processes. However, in order to ensure the required strengths in the further working of the nonwoven fabric other additional binders can also be introduced and/or known consolidation/mechanical strengthening methods, such as needling, can be used. In addition to the possibility of a mechanical strengthening, e.g., by calendaring or needling, in particular the hydrodynamic needling is also mentioned here. Chemical and/or thermoplastic binders are suitable as binders, as long they are compatible to the thermoplastic binder composition according to the present disclosure.

### Fiber Layer

The fiber-forming materials for the nonwoven fabric are optionally natural fibers and/or fibers of synthesized or natural polymers, ceramic fibers, mineral fibers, such as glass fibers, that can also be used in the form of mixtures. The non-woven fabric can be formed of staple fibers or from filaments, that is, infinitely long fibers.

### Mineral- and Ceramic Fibers

The mineral- and ceramic fibers are optionally aluminosilicate fibers (glass fibers), ceramic fibers, dolomite fibers, wollastonite fibers or fibers of vulcanites, optionally basalt fibers, diabase fibers and/or melaphyr fibers. Diabases and melaphyrs are designated combined as paleobasalts and diabase is also often designated as greenstone.

The average length of the staple fibers in the non-woven fabric of mineral fibers used in accordance with the disclosure is between 8 and 30 mm, optionally 10 to 30 mm.

In a further embodiment of the disclosure the mineral fiber non-woven fabric contains a mixture of endless fibers and staple fibers. The average fiber diameter of the mineral fibers is between 6 and 25 μm, optionally between 8 and 24 μm, and optionally between 8 and 15 μm.

The weight per unit area of the nonwoven fabric of mineral fibers is between 15 and 500 g/m², optionally 30 and 250 g/m², wherein these data refer to a textile structure without any binders, additives or coatings.

### Glass Fibers

Glass fibers for the non-woven fabrics are particularly suitable. They are constructed from filaments, that is, infinitely long fibers or of staple fibers. The average length of the staple fibers is between 5 and 90 mm, optionally 8 to 30 mm. In a further embodiment of the disclosure the glass fiber non-woven fabric contains a mixture of endless fibers and staple fibers.

The mean diameter of the glass fibers is between 5 and 30 micron, optionally between 6 and 25 micron.

In addition to the previously cited diameters so-called glass microfibers can also be used. The average diameter of the glass microfibers may be between 0.1 and 5 μm. The microfibers forming the textile surface can also be present in mixtures with other fibers, optionally glass fibers. Moreover, a layer-shaped construction of microfibers and glass fibers is also possible.

The nonwoven fabric can also additionally have a reinforcement of fibers, threads or filaments. Reinforcement threads are optionally multi-filaments or rovings based on glass, polyester, carbon or metal. The reinforcement threads can be used as such or also in the form of a textile surface structure, e.g., as fabric, laying, knitted fabric, knitwear or non-woven fabric or scrims. The reinforcements optionally consist of a parallel thread sheet or of a laying.

The weight per unit area of the nonwoven fabric of glass fibers is between 15 and 500 g/m², optionally 40 and 250 g/m², wherein the data refers to a surface structure without any binders, additives or coatings.

Suitable glass fibers comprise-among others-those manufactured from Aglass, C-glass, E-glass, S-glass, T-glass or R-glass.

In some embodiments, the fiber nonwoven layer comprises glass or polymer fibers or a mixture thereof, optionally glass fibers.

The fiber layer may include glass fibers having a mean diameter of between 6 micron and 25 micron and a length between 8 mm and 30 mm.

The fiber layer optionally has a thickness between 0.1 mm and 10 mm, optionally between 0.2 mm and 0.6 mm and an average weight of between 10 g/sqm and 300 20 g/sqm, and optionally 20 g/sqm and 150 g/sqm.

The fibers nonwoven layer may include mineral fibers such as C-glass fibers, E-glass fibers, S-glass fibers, T-glass fibers, aluminosilicate fibers, ceramic fibers, dolomite fibers, wollastonite fibers or fibers of vulcanites, optionally basalt fibers, diabase fibers, melaphyr fibers, more optionally basalt fibers or a combination thereof, optionally 25 C-glass, E-glass, S-Glass, T-Glass or a mixture thereof.

### Polymer Fibers

Among the nonwoven fabric of fibers of synthetic polymers, non-woven fabrics, especially so-called spunbonds, that is, spunbonded non-woven fabrics produced by a tangled deposit of melt-spun filaments are suitable. They consist of endless synthetic fibers of melt-spinnable polymer materials. Suitable polymer materials are, e.g., polyamides such as, e.g., polyhexamethylene diadipamide, polycaprolactam, aromatic or partially aromatic polyamides (“aramids”), aliphatic polyamides such as, e.g., nylon, partially aromatic or fully aromatic polyesters, polyphenylene sulfide (PPS), polymers with ether- and keto groups such as, e.g., polyetherketones (PEK) and polyetheretherketone (PEEK), polyolefins such as, e.g., polyethylene or polypropylene, cellulose or polybenzimidazoles. In addition to the previously cited synthetic polymers, those polymers are also suited that are spun from solution.

The spunbonded non-woven fabrics optionally consist of melt-spinnable polyesters. In principle, all known types of polyester material suitable for the manufacture of fibers are considered as polyester material. Polyesters containing at least 95 mole % polyethyleneterephthalate (PET), especially those of unmodified PET, are especially suitable. When calandered, spunbond materials are produced, and a spray gun and infrared dryer may installed.

If the composite materials in accordance with the disclosure should additionally have a flame-retardant action, it is advantageous if they were spun from polyesters modified in a flame-retardant manner. Such polyesters modified in a flame-retardant manner are known.

The individual titers of the polyester filaments in the spunbonded non-woven fabric are between 1 and 16 dtex, optionally 2 to 10 dtex.

In a further embodiment of the disclosure the spunbonded non-woven fabric can also be a bonded fiber fabric hardened by melt binder and which contains carrier fibers and melded fibers. The carrier fibers and melded fibers can be derived from any thermoplastic, fiber-forming polymers. Such spunbonded non-woven fabrics hardened by melt binder are described, e.g., in EP-A-0,446,822 and EP-A-0,590,629.

In addition to endless filaments (spunbond method) the textile surface can also be constructed of staple fibers or mixtures of staple fibers and endless filaments. The individual titers of the staple fibers in the non-woven fabric are between 1 and 16 dtex, optionally 2 to 10 dtex. The staple length is 1 to 100 mm, optionally 2 to 50 mm, and optionally 2 to 30 mm. The nonwoven fabric can also be constructed of fibers of different materials in order to be able to achieve special properties.

The nonwoven fabric can also additionally have a reinforcement of fibers, threads or filaments. Multi-filaments or rovings based on glass, polyester, carbon or metal are suitable as reinforcement threads. The reinforcement threads can be used as such or also in the form of a textile surface structure, e.g., as fabric, laying, knitted fabric, knitwear or non-woven fabric. The reinforcements optionally consist of a parallel thread sheet or a laying.

The filaments and/or staple fibers constructing the bonded fiber fabric can have a practically round cross-section or also other forms such as dumbbell-shaped, kidney-shaped, triangular or tri- or multi-lobed cross-sections. Hollow fibers and bi- or multi-component fibers can also be used. Furthermore, the melded fibers can also be used in the form of bi-component or multi-component fibers.

The fibers forming the nonwoven fabric can be modified by customary additives, e.g., by antistatic agents such as carbon black.

The weight per unit area of the nonwoven fabric of fibers of synthetic polymers is between 10 and 500 g/m², optionally 20 and 250 g/m², wherein the data refers to a surface structure without any binders, additives or coatings.

### Natural Fibers

The natural fibers are vegetable fibers, fibers derived from grasses, straw, wood, bamboo, reed and bast, or fibers of animal origin. Plant fibers is a collective concept and stands for seed fibers such as cotton, kapok or poplar fluff, bast fibers such as bamboo fiber, hemp, jute, linen or ramie, hart fibers such as sisal or manila, or fruit fibers such as coconut. Fibers of animal origin are wools, animal hairs, feathers and silks.

The weight per unit area of the nonwoven fabric of natural fibers is between 20 and 500 g/m², optionally 40 and 250 g/m², wherein the data refers to a surface structure without any binders, additives or coatings

### Natural Polymer Fibers

The textile surfaces of fibers of natural polymers are cellulose fiber such as viscose or vegetable or animal protein fibers.

Among the textile surfaces of cellulose fibers non-woven fabrics are especially suitable. They are constructed from filaments, that is, infinitely long fibers and/or from staple fibers. The average length of the staple fibers is between 1 and 25 mm, optionally 2 to 5 mm.

The average diameter of the cellulose fibers is between 5 and 50 μm, optionally between 15 and 30 μm.

The textile surface structure can also be Kraft papers, overlay papers, balance papers or decor papers. Such papers are particularly beneficial when used as core papers and/or as surface paper in CPL and HPL.

### Binder Application

The application of the thermoplastic binder composition according to the present disclosure onto the nonwoven fibers can take place with the aid of known methods. In addition to spraying on, impregnating and pressing in, the binder can also be applied by coating or by rotary nozzle heads. If following the inline process path binder composition according to the present disclosure can also be part of the white water or any other aqueous means used for the production of the nonwoven layer.

A further method is the application of the new binder composition according to the present disclosure by the application of foam. In the application of foam binder foam is produced with the aid of a foaming agent in a foam mixer that is applied by suitable coating aggregates onto the non-woven fabric. The application can also take place here by rotary nozzle heads.

In the foam coating binder composition there are basically no limitations regarding the foaming agent. Suitable foaming agents are ammonium stearates or succinic acid 10 esters added with 1%-5% by weight in dry mass to the binder. Furthermore, the already described catalysts are mixed in if required. The solids content of the foam is at least 40%, optionally at least 50%.

The total binder content in the nonwoven fabric is between 10% and 80% based on total weight of the dried surface structure and includes all applied binder components and additives.

### Functional Materials

The composite material comprising the thermoplastic binder composition can contain additives and/or functional materials. The additives and functional material can be applied at the same time with the thermoplastic binder composition, e.g., as mixture or as individual components, or before or after the application of the binder composition. In as far as the thermoplastic binder composition is applied by foam application it is advantageous to apply the functional material with the foam or distributed in the foam or to apply the functional material onto the still fresh foam.

In order to fix the functional materials a binder can be additionally added for fixing the functional materials on the nonwoven fabric. The same binder composition is optionally selected here as is present in the textile surface structure. The content of functional material is determined by the subsequent use.

The application of the functional material used takes place as a function of the nature of the particular functional material by known techniques. The application can also take place by rotary nozzle heads.

The functional material is optionally flame proofing agents, materials for discharging electrostatic charges, materials for screening off electromagnetic rays, organic or inorganic pigments, especially colored pigments, materials that increase the resistance to wear and/or slippage, or decorative layers. The functional materials are optionally arranged on the side of the nonwoven fabric and can at least partially pass through the non-woven fabric.

In a variant of the method an additional binder is added to fix the functional materials on the nonwoven layer. The same binder (B-stage binder) as is present in the nonwoven layer is optionally selected here. The content of functional materials is determined by the subsequent use.

### Flame Proofing Agents

The flame proofing agents are inorganic flame proofing agents, organophosphorus flame proofing agents, nitrogen-based flame proofing agents or intumescences flame proofing agents. Halogenated (brominated and chlorinated) flame proofing agents can also be used but are less suitable on account of their risk evaluation. Examples for such halogenated flame proofing agents are polybrominated diphenylether, e.g., decaBDE, tetrabromobisphenol A and HBCD (hexabromocyclododecane).

The nitrogen-based flame proofing agents are melamines and urea. The organophosphorus flame proofing agents are typically aromatic and alkyl esters of phosphoric acid. TCEP (trischloroethylphosphate), TCCP (trischloropropylphosphate), TDCCP (trisdichloroisopropylphosphate), triphenylphosphate, trioctylphosphate (tris-(2-ethylhexyl) phosphate) are optionally used.

The inorganic flame proofing agents are typically hydroxides such as aluminum hydroxide and magnesium hydroxide, borates such as zinc borate, ammonium compounds such as ammonium sulfate, red phosphorus, antimony oxides such as antimony trioxide and antimony pentoxide and/or laminated silicates such as vermiculite. In addition, suitable agents are expandable graphite.

### Antistatic Agents

Antistatic- and electromagnetic screening effects can be achieved by the use of agents for raising the electrical conductivity.

The antistatic agents are usually particles that are electrically conductive. Suitable materials are electrically conductive carbons such as carbon black, graphite and carbon nanotubes (C-nanotubes), conductive plastics or fibers of metal or metallic components.

### Electrically Conductive Materials

The materials for screening electromagnetic rays are usually electrically conductive materials. They can be built up in the form of foils, particles, fibers or wires and/or textiles surface structures of the previously cited materials.

### Fillers

Fillers are materials such as CaCO₃, coated CaCO₃, coated or uncoated Kaolin, talcum, gypsum or silica, etc.

### Pigments

The inorganic or organic pigments are particulate materials. In addition to fillers such as CaCO₃, talcum, gypsum or silica, the pigments, to the extent that they should increase the value of the composite material, are in particular pigments that can be used in colors.

### Hydrophobic Agents

Hydrophobic agents are additives which are able to increase or modify the compatibility of the B-stage binder composition to the carrier or the nonwoven fabric. Prominent but not limiting examples are fluorine or silane containing components which can greatly improve the compatibility of the binder to metal and glass surfaces.

### Decorative Elements

The decorative layers are decorative elements. This is understood to include decorative layers and patterns that increase the value of the composite material. Examples of such patterns are veneers, cork, decorative papers, foils with wood graining, overlay papers, HPL, CPL (laminates built up in multilayers) or chips of paper or plastic with different colors that are also designated as decorative semifinished products. For their part, these decorative semifinished products can contain NW with new binders and/or one or more textile surfaces, optionally non-woven or non-woven fabric layers.

### Method of Manufacturing a Semi-Finished Composite Material

Subject matter of the present disclosure is a method for the manufacture of a semi-finished composite material comprising the measures:
a) Supplying of a nonwoven fabric, whereas the nonwoven fabric optionally has received a pre-strengthening,
b) Application of at least one binder composition comprising (i) at least one base binder and (ii) at least one polymer wax emulsion, optionally a thermoplastic emulsion, in particular the emulsion is based on polyolefin and/or polyurethane or PVC emulsions or PET,
c) Optionally applying at least one functional material to the nonwoven fabric according to b),
d) Drying the nonwoven fabric.

The nonwoven fabric in measure a) has an additional pre-strengthening treatment as already described above. However, it is also possible to apply the binder composition according to the present disclosure to the nonwoven layer during its formation. In this so-called in-line process measures a) and b) step are carried out simultaneously at the same time during the formation of the nonwoven layer. The inline process does not necessarily require pre-strengthening means if the base binder composition itself can provide sufficient binding strength.

The application of the binder in step b) can be accomplished as described above. Optionally, functional materials can be applied. The functional materials can be applied together with the binder or after the application of the binder. The subsequent drying step removes the water and cures the base binder. The temperature and duration of the drying step depends on the materials used, the process, and the planned applications. It is particularly important to set the temperature and drying duration according to the required degree of curing binder composition E.g. a polyolefin binder cures at 150 degree C and the base binder at 200 degree C.

The process results in a semi-finished product, comprising a nonwoven, thermoplastic binder composition according to the present disclosure, and optionally functional materials. The semi-finished product can be used for the manufacturing of laminates of all kind, in particular as reinforcement in laminates or as components of CPL or HPL, as facers and other materials.

### Semi Finished Product

### Decorative Semi-Finished Product

Furthermore, the Disclosure Also Comprises Decorative Semifinished Products, in Particular CPL and HPL, Comprising:
a) at least one non-woven fabric, and
b) at least one binder composition comprising (i) at least one base binder and (ii) at least one polymer wax emulsion, optionally a thermoplastic emulsion, in particular the emulsion is based on polyolefin and/or polyurethane or PVC emulsions or PET or similar, which is cured, and wherein the nonwoven fabric has optionally an additional strengthening, and
c) at least one decorative layer, optionally a layer or pattern of veneers, cork, decorative papers, foils with wood graining, overlay papers, High Pressure Laminate (HPL), Continuous Pressure Laminate (CPL) (laminates built up in multilayers), metal foils of Aluminum or Cuprum.

CPL and HPL typically consist of several, usually 2-50 layers of Kraft paper or nonwoven that are impregnated with a melamine, MUF or phenol B-stage binder and exhibit formaldehyde.

The CPLs and/or HPLs in accordance with the disclosure optionally have between 1 and 25 layers of a non-woven fabric with a B-stage binder. In addition, the CPLs and/or HPLs can have even more layers of Kraft paper impregnated with a melamineformaldehyde, melamine-urea-formaldehyde or phenol-formaldehyde resin.

Laminates and CPL or HPL in this case of disclosure resulting to improved flexibility and post-forming characteristics, in particular 3-dimensional forming capabilities. CPL or HPL can also comprise veneer layers.

The manufacture of the decorative semifinished product takes place by lamination under the action of pressure and heat in such a manner the layers are laminated together. The lamination can take place by discontinuous or continuous pressing or by rolling. The parameters of pressure, temperature and dwell time are selected in accordance with the B-stage binder used.

The thermoplastic binder composition according to the disclosure increases the compatibility to the carrier materials, such as to WPC (wood plastic composites), plastics and metals.

### Laminates and Composites

### Method of Manufacturing Composites

Subject matter of the present disclosure is a method for manufacturing a laminate composite material, wherein the method comprises the steps of
a. providing a.1. mineral fibers in an aqueous fiber slurry in a wet laid process onto a transport belt or a.2 providing PET fibers or mixtures of PET fibers with mineral fibers in an aqueous fiber slurry in a wet laid process onto a transport belt,
b. removing the white water at least partly,
c. applying a thermoplastic binder composition comprising at least one aqueous thermoplastic binder and 25 to 75% by wt. of at least one polymer wax emulsion based on the total weight of the binder,
d. drying the resulting glass fiber nonwoven,
e. laminating a cover layer to the glass fiber nonwoven at a temperature of between 100 Celsius to 250 Celsius at a pressure of between 1 bar and 40 bar.

In some embodiments, the thermoplastic binder composition in step c is applied by curtain coating or sprayed on one side.

Subject matter of the present disclosure is a method for the manufacture of a composite material comprising the measures:
a) Supplying of a carrier (e.g. WPC),
b) Application of a nonwoven fabric onto at least one surface of the carrier, the nonwoven fabric having at least one binder composition comprising (i) at least one base-binder and (ii) at least one polymer wax emulsion, optionally a thermoplastic emulsion, in particular the emulsion is based on polyolefin and/or polyurethane or PVC or PET or similar, which is cured, and wherein the nonwoven fabric has optionally an additional strengthening, and optionally at least one functional material,
c) Lamination of the construction obtained according to step b) under the action of pressure and heat,
d) optional application of at least one further protective layer and
e) drying.

The carrier used in accordance with step a) is optionally wooden materials like engineered wood, papers, cork, cardboards, mineral plates, wood-plastic-composites WPC and/or so-called honeycombs. Honeycombs are structural components with three-dimensional reinforcement structures that make possible an extraordinary stability and strength with low weight at the same time on account of their construction (bee honeycomb structure). Such honeycombs have been used for some time in many areas of application, among others also as inner reinforcement of plate-shaped elements in the construction area or in furniture. It also includes facer materials for, e.g., polyiso boards for building insulation applications.

### Wooden Carrier

The wooden materials are plate-shaped or strand-shaped wooden materials manufactured by mixing the different wooden particle forms with natural and/or synthetic binding agents during a hot pressing. The wooden materials used in accordance with the disclosure optionally comprise plywood or laminated wood, wood-chip material, especially chipboards and OSB (Oriented Strand Boards), wood fiber material, especially porous wood fiber boards, open-diffusion wood fiber boards, hard (high-density) wood fiber boards (HDF) and medium-density wood fiber boards (MDF), and Arboform. Arboform is a thermoplastically workable material of lignin and other wood components.

### Papers and Cardboards

The papers are optionally papers on the basis of natural, synthetic, mineral or ceramic fibers or also of mixtures of these fiber types.

The cardboards are optionally cardboards on the basis of natural and/or synthetic fibers, which also comprise mineral and/or ceramic fibers as well as mixtures of these fiber types.

### Mineral Plates

The mineral plates are optionally commercial mineral cardboard plates with cardboard coating on both sides, gypsum fiber plates, ceramic fiber plates, cement plates or lime plates. The plates can optionally be reinforced with natural and/or synthetic fibers, wherein these can also comprise mineral and/or ceramic fibers. The reinforcement fibers can be present in the form of filaments, monofilaments or as staple fibers.

In addition to the described materials the carrier can also consist of cork, veneer or other sustainable vegetable materials.

The carrier can also be a WPC (wood-plastic-composite), a foam or other plastic sheet materials. In the case of foam, the material needs to have enough strength to withstand the pressure during the laminating process.

The weight per unit area of the carriers contained in the composite material is a function of the final application and is not subject to any particular limitation.

The lamination of the construction obtained according to step b) takes place in step c) under the action of pressure and heat in such a manner that the binder present in the textile glues to. The lamination can take place by discontinuous or continuous pressing or by rolling. The parameters of pressure, temperature and dwell time are selected in accordance with binder types used.

The application of at least one further protective layer and its drying in accordance with step d) and may include lacquers such as powdered lacquers, clear lacquers or transparent lacquers, optionally scratch-proof lacquers that protect the functional layer against mechanical influences or against UV ageing.

The cover layer may include a metal layer or a plastic layer or a paper layer or a cardboard layer, optionally a metal foil, an aluminum foil or copper foil or plastic decor outer layer. The plastic decor layer can consist of PP, PA, PE, PET, PVC or combinations thereof.

Aluminum foil having a thickness of e.g. 2, 5, 10, 20, 30, 50, 100, or 200 μm can be used according to the targeted application, wherein thinner aluminum foils are targeted for low weight applications, wherein thickness between 30 to 100 or to 200 μm are targeted for applications that require a more robust surface in handling or product applications in the construction industry.

Subject matter of the present disclosure further is an insulation product, comprising a polyurethane foam core or other chemical compatible foams and at least one laminate composite material according to the disclosure on at least one surface.

Subject matter of the present disclosure further is an insulation product comprising a mineral wool product and a laminate composite material according to the disclosure.

Subject matter of the present disclosure further is the use of a laminate composite material according to the disclosure in gypsum panels, in interior construction, as facers for polyiso boards, linings or floor coverings.

Subject matter of the present disclosure further is a Laminate composite material according to the disclosure forming a composite board or a decorative board or decorative laminate or a building membrane.

### Test Methods

Air permeability: The air permeability is determined according to DIN EN ISO 9237.

Area weight: The weight per unit area [area weight] is determined according to DIN EN 12127/DIN EN ISO 29073-1.

Loss on ignition: The Loss on ignition (LOI) is determined according to ISO 1887.

Thickness: The thickness is determined according to DIN EN ISO 9073-2

Tensile strength: The tensile strength (mechanical strength) is determined according to DIN EN 29 073-3 Specific tensile strength: The tensile strength is determined according to DIN

EN 29 073-3. The specific tensile strength is calculated via the formula: (tensile strength in MD+tensile strength in CD)/((loss on ignition/100)*area weight) [N/g LOI]. The specific tensile strength is the measured tensile strength of a sample in loading direction (MD, CD) of the load during mechanical stress testing divided by loss on ignition and multiplied with the area weight of such sample.

Specific Volume [cm³/g]: To determine the specific volume of a sample area, the area weight of a respective sample according to the embodied examples was measured in accordance to DIN EN ISO 29073-1 (1992-08). Afterwards an LOI was performed to determine the binder amount and subtract the binder weight, thus obtaining the pure fiber weight plus aluminum foil weight of the sample. Based on these results the specific glass fiber volume of the mat was determined. The specific volume is indicative about the ability of the glass fiber to separate completely into individual fibers without fiber bundles and build a compact net of glass fibers without clumping and building agglomeration knots in the mat.
(i) Test pieces each having a size of 30 cm×5 cm whose long side corresponded to the machine direction are collected from three points per 1 m positioned at equal intervals along the width direction.
(ii) Tensile tests were carried out at a clamping distance of 20 cm and a tensile rate of 10 cm/min using a constant speed elongation type tensile tester.
(iv) The strength at break was read and rounded to the nearest integer to determine the tensile strength (N/5 cm).
(v) The tensile strength (N/5 cm) value obtained in the above (iv) is divided by the value of the weight per unit area (g/m²), and the resulting value is rounded to one decimal place to calculate the tensile strength per weight per unit area for each of the machine direction and the cross direction.

The tensile strength in the machine direction of the nonwoven layer for use in filters according to embodiments of the present disclosure was measure in machine direction (MD tensile strength) and in 90 degree to the machining direction (CD tensile strength).

The machine direction refers to a sheet conveying direction during the manufacture of the nonwoven layer that is, the winding direction of the roll of the nonwoven layer fabric. The cross machine direction refers to a direction perpendicular to the sheet conveying direction during the manufacture of the nonwoven.

### EXAMPLES

An example of the disclosure is an aluminum lamination product comprising 30% by weight thermoplastic binder and 70% by weight glass fiber. The weight % are calculated based on the final weight of the glass fiber non-woven layer comprising the binder, but without the weight of the aluminum foil. Aluminum foil thickness of 2, 5, 10, 20, 30, 50, 100, or 200 μm can be used according to the targeted application, where thinner aluminum foils are targeted for low weight applications, wherein thickness between 30 to 100 or to 200 μm are targeted for applications that require a more robust surface in handling or product applications in the construction industry. In Example 1 to Example 11 an aluminum foil with a thickness of 2 μm was used. The binder was a mixture of a polypropylene wax emulsion and an PVAc based dispersion binder (Celanese-Mowilith 15 DN 60). For the lamination, a press may be used at a temperature of 160 C and a low pressure of 20 bar for a time interval of 2 minutes.

In a first set of embodiments according to Example 1 to Example 11 different laminate composite materials were manufactured with the parameters and conditions listed in Table 1 and Table 2. The drying temperature was set to 160 C.

A laminate composite material was produced comprising an aluminum foil and a glass fiber nonwoven layer. The aluminum foil was a standard type for insulation with 2 micron thickness, respectively 5.4 g/m² specific weight.

The glass fiber nonwoven comprised 27% to 31.4% (measured by LOI) of a binder composition according to Table 1. In example 1 to example 11 according to Table 1 different binder compositions were applied to the laminate composite material.

According to Example 1 to Example 5 of the exemplary embodiments in Table 1 an anionic emulsion of an oxidized HDPE wax (Aquacer® 1547) was dispersed in water and applied to the glass staple fiber web. Aquacer® 1547 sold by BYK-Chemie GmbH is a HDPE-based wax emulsion, namely an anionic emulsion of an oxidized HD polyethylene wax. The non-volatile matter content at (60 min., 125 °C) is 35% by weight. It forms a dispersion in water. The melting point of the wax content is 125 °C and the viscosity is 40 mPa·s at 23 °C and a stirring rate of D=400/s. The pH value is 9.7. Examples 1 to 5 are comparative examples as the binder composition only comprises a polymer wax emulsion but no additional binder component.

According to example 6 to example 11 of the exemplary embodiments in Table 1 the HDPE wax emulsion (Aquacer® 1547) was mixed with an aqueous polyvinyl acetate emulsion (Mowolith® DN 60) in different ratios and applied to the glass staple fiber web. Mowilith® DN 60 is an aqueous polymer dispersion based on vinyl acetate and stabilized by polyvinyl alcohol sold by Celanese Sales Germany GmbH. Mowolith® DN 60 has a solids content at (130 °C; 30 min-ISO 3251) of between 59-61%. It has a Brookfield viscosity at (25 °C; 6/20-ISO 2555) of between 10000-18000 mPa·s. The pH value is between 4.0 to 6.0 in a 1:1 water dilution. It has a glass transition temperature according to ISO 16805 of approx. 38 °C.

The glass fibers nonwoven comprised between 80% and 100% of E-glass fibers having an average diameter of 12.5 micron and a length of 18 mm and between 20% and 0% of E-glass fibers having an average diameter of 11 micron and a length of 12 mm.

Non woven fiber webs or mats with an area weight of between 40.5 g/m² to 152 g/m² were produced. The dry weight content of the binder in the manufactured nonwoven staple glass fiber mat was measured by loss on ignition (LOI) testing.

TABLE 1
Composition of nonwoven layers binder and fiber, 1-5 comparative
examples, 6-11 according to the disclosure and properties
of the nonwoven layer *Aquacer 1547 from BYK-Chemie GmbH
having 35% by wt. non volatile content + Mowolith
DN 60 from 5 Celanese Sales Germany GmbH having 59-61%
solid content. The laminate composite material had the
following properties listed in table 2.

| | | | | Area weight | |
|---|---|---|---|---|---|
| | | | | [g/m²] | |
| | | Glass | Glass | Glass fiber | |
| | | Fiber | Fiber | non-woven | |
| | | Type | Type | with binder | |
| | | First | Second | composi- | |
| | | Staple | Staple | tion + | |
| Exam- | Binder | Glass | Glass | aluminum | LOI |
| ple | Composition | Fibers | Fibers | foil | [%] |
| 1 | Anionic emulsion | 100% | — | 142 | 27 |
| | of an oxidized | TRE | | | |
| | HD polyethylene | 12.5/18 | | | |
| | wax*/Water 1:1 | | | | |
| 2 | anionic emulsion | 100% | — | 152 | 28.5 |
| | of an oxidized | TRE | | | |
| | HD polyethylene | 12.5/18 | | | |
| | wax*/Water 1:1.5 | | | | |
| 3 | | 80% TRE | 20% TRE | 145 | 28 |
| | | 12.5/18 | 11/12 | | |
| 4 | | 80% TRE | 20% TRE | 60.2 | 29.7 |
| | | 12.5/18 | 11/12 | | |
| 5 | | 80% TRE | 20% TRE | 40.5 | 31 |
| | | 12.5/18 | 11/12 | | |
| 6 | | 80% TRE | 20% TRE | 61 | 29.8 |
| | | 12.5/18 | 11/12 | | |
| 7 | | 80% TRE | 20% TRE | 61.2 | 31 |
| | | 12.5/18 | 11/12 | | |
| 8 | | 80% TRE | 20% TRE | 60.5 | 31.4 |
| | | 12.5/18 | 11/12 | | |
| 9 | | 80% TRE | 20% TRE | 61 | 31.2 |
| | | 12.5/18 | 11/12 | | |
| 10 | | 80% TRE | 20% TRE | 60.6 | 31.5 |
| | | 12.5/18 | 11/12 | | |
| 11 | | 80% TRE | 20% TRE | 58.5 | 27.5 |
| | | 12.5/18 | 11/12 | | |

The laminate composite material had the following properties listed in table 2.

TABLE 2
Properties of laminate composite materials

| | | | | Air | |
|---|---|---|---|---|---|
| | | Tensile | Tensile | permeability | |
| | | Modulus | Modulus | [l/m²s] | |
| | Thickness | (CMD) | (MD) | Dried glass | Spec. Vol. |
| Example | [mm] | [N/m²] | [N/m²] | fiber mat | [cm³/g] |
| 1 | 1.27 | 315 | 336 | 1844 | 12.2 |
| 2 | 1.49 | 295 | 406 | 1688 | 13.7 |
| 4 | 0.63 | 325 | 376 | 2685 | 14.9 |
| 6 | 0.49 | 479 | 637 | 2189 | 11.4 |
| 8 | 0.5 | 464 | 586 | 2257 | 12 |
| 10 | 0.53 | 417 | 510 | 2738 | 12.8 |

Table 2 shows the specific volumes of glass fiber mat part in the laminate according to the examples in Table 2. The aluminum density is out of the scope of the following reasoning, as the aluminum density is constant for all samples and a constant part. Table 2 reflects an increase in the specific volume by adding a second type of shorter staple glass fiber. An increased specific volume is a desired glass fiber property as this value is related to the ability of the glass fibers to build a homogeneous glass fiber slurry without entanglements and without clogging. The fiber with higher specific volume shall show a better dispersion in the forming slurry.

The air permeability distribution of glass fiber mats according to the examples 6, 8 and 10 in table 2 shows an increasing air permeability in samples containing higher amount of polymer wax emulsion.

Table 2 illustrates the elastic modulus or in this case tensile modulus test data in machine direction (MD) and in cross machine direction (CMD) for the laminate composite material comprising different binder composition and distinct mixtures of E-glass fibers comprising an aluminum foil. The elastic modulus of the laminate is defined as the slope of its stress-strain curve during an elastic tensile deformation region. A stiffer material will have a higher elastic modulus.

As shown in the embodiments the tensile modulus (elastic modulus) of the laminate composite is lower in samples as to examples 1, 2 and 4 wherein the glass fiber was consolidated solely by the polymer wax emulsion.

The tensile modulus was between 295 [N/m²] and 325 [N/m²] in the cross direction (CMD) measurements in these embodiments.

An increase in tensile modulus (CMD) at about 52% could be observed in example 6 (Mowolith DN 60 70% x/Aquacer 1547 30%) compared to example 1 (Aquacer 1547/Water 1:1). The vinyl acetate polymer dispersion creates a stronger consolidation and binding within the glass fiber web and thus higher e-modules. The tensile modulus decreased at higher polymer wax emulsion contents in the binder.

Therefore, a binder composition comprising both an aqueous polymeric binder and a polymer wax emulsion will result in a laminate with high mechanical strength and elasticity.

In further embodiments, a cover layer is disclosed. Furthermore, the disclosure relates to a fiber-based insulation product comprising at least one core layer comprising insulation material and at least one cover layer, optionally forming the outermost surface, comprising a nonwoven fiber mat, comprising mineral fibers and/or polymer fibers and a new binder composition comprising at least one polymer wax emulsion, optionally a thermoplastic emulsion, in particular the polymer wax emulsion being based on polyolefin and/or polyurethane (PU) and/or polyvinyl chloride (PVC) or polyethylene terephthalate (PET) or similar, and at least one base binder of polyvinyl alcohol or polyacrylate or polyvinyl acetate, or a combination thereof.

Such cover layers exhibit increased flexibility and improved handling capabilities, which is advantageous for the processing, e.g. adhering the cover layer respectively the facer onto an insulation layer. Furthermore, the cover layer shows water-repellent properties due to the waxy hydrophobic nature of the new binder composition. Moreover, these properties are accompanied by an improved impact resistance of the cover layer, enhancing the durability and mechanical performance of the fiber-based insulation product. In accordance with another aspect of the disclosure, a method is provided for manufacturing a fiber-based insulation product according to the disclosure.

Various embodiments will now be described for a fiber-based insulation product with a cover layer, optionally forming the outermost surface, comprising at least one nonwoven fiber mat, comprising mineral fibers and/or polymer fibers and a binder composition, wherein the binder composition comprises at least one polymer wax emulsion, optionally a thermoplastic emulsion, in particular the polymer wax emulsion is based on polyolefin and/or polyurethane and/or PVC emulsions and/or PET or similar, and at least one base binder of polyvinyl alcohol, polyacrylate, or polyvinyl acetate, or a combination thereof.

The above binder composition is applied to a nonwoven fabric which then can be used for the production of a fiber-based insulation product, for example an insulation roll or board. The binder composition can also be applied during the manufacturing of the nonwoven fabric and can also be applied separately by a spray gun and/or bar on one side. In some embodiments, the cover layer is adhered to the core layer which comprises the insulation material.

A particular advantage of the disclosure is that at minimum only two layers are needed, with the binder composition being applied, particularly in combination with the bonding process of the cover layer and the core layer being described, thus eliminating the additional step of laminating the layers in another separate production step or the need for additional surface forming layers.

This is advantageous in many ways. Among other things, it saves material and costs and simplifies the manufacturing process.

The term “nonwoven fabric” as used herein refers to the nonwoven fiber mat before being formed by use of the binder composition (“prefabricated product”).

The thermoplastic binder composition according to various embodiments contains at least one so called base binder. The binder composition comprises such base binder together with at least one polymer wax emulsion, optionally a thermoplastic emulsion, in particular based upon a polyolefin emulsion, or a polyurethane based emulsion or PVC emulsions or PET or similar.

In one embodiment, the fiber-based insulation product comprises a binder composition, wherein the emulsion wax comprises polypropylene (PP), polyethylene (PE), or a combination thereof. The polymer wax emulsion is optionally selected from the group consisting of polypropene wax emulsions (PP wax), polyethylene wax emulsions (PE Wax), polyethylene terephthalate wax emulsions (PET Wax), polyurethane wax emulsions (PU Wax), polyacrylate wax emulsions and mixtures thereof. The polypropene wax and the polyethylene wax may be oxidized polypropene wax or oxidized poylethylene wax. The binder composition of the present disclosure can be applied to nonwoven fabrics which can be used for the manufacturing of composite materials. The binder composition can be applied during or after the forming of the nonwoven fabric. Optionally, the binder composition is used to form the nonwoven fabric to a nonwoven fiber mat.

The binder composition is applied to the nonwoven structure and then partly cured. The nonwoven structure comprising the binder can then be processed into composites. The binder composition comprises at least one polymeric base binder comprising polyvinyl acetate (PVAc), polyacrylate, polyvinyl alcohol (PVA), starch, sugar derivatives, lignin or mixtures thereof, optionally comprising at least one PVAc and/or at least one polyacrylate. Base binder are aqueous polymeric binder, optionally binders based on polyvinyl emulsions, polyacrylate emulsions, aqueous polymer dispersions based on vinyl acetate and their mixtures. Such binders are usually cured at temperatures of ca. 150 °C-250 °C in one step.

The use of a thermoplastic binder offers opportunities in view of recycling of such product, whereas thermoset binder systems typically require pyrolysis at high temperatures, thermoplastic binder such as PP are meltable in a range between 200 C-250 °C. Thus, this is an opportunity for recycling and sustainability, as the thermoplastic binder can be melted and reprocessed, unlike thermoset binders.

The polymer wax emulsion is optionally selected from the group consisting of polyolefin wax emulsions, polypropylene wax emulsions (polypropene wax emulsions, PP wax), polyethylene wax emulsions (polyethylene wax emulsions, PE Wax), polyethylene terephthalate wax emulsions (PET Wax), polyurethane wax emulsions (PU Wax), acrylic wax emulsions and mixtures thereof. Due to the waxy hydrophobic nature of the new binder composition the cover layer exhibits a water repellent property, which improves the insulation products' resistance against water uptake or water vapor diffusion into the insulation material.

First internal tests were carried out to check the water repellent properties of the disclosure. When a drop of water was applied to the cover layer of a product according to this disclosure, it was found that the drop of water remained on the surface of the cover layer for a few seconds, while the water drop on a non-pressed nonwoven mat penetrated immediately.

In one embodiment, the fiber-based insulation product comprises the binder, which further comprises a carbohydrate binder component selected from monosaccharide, disaccharide, trisaccharides, tetrasacharides, pentasaccharides and/or reaction products thereof, or a combination thereof.

In one embodiment, the fiber-based insulation product comprises at least one base polymer wax emulsion, which is colored by black pigments. Optionally, the polymer wax emulsion comprises black pigments, for example with fine black carbon particles. When exposed to heat and some pressure, the copolymer softens and bonds well with another surface, optionally a core layer, to form a, optionally flat, composite.

The binder composition contains at least 10% polymer wax emulsion, based on the total solid content of the binder composition, optionally up to a value of approximately 75%. The optimum value depending on the binder used.

In one embodiment, the fiber-based insulation product comprises at least one polymer wax emulsion, which has a solids content of 25 to 55% by weight, optionally 40% by weight.

In one embodiment, the binder composition comprises 5 to 70% by weight, optionally 10 to 50%, more optionally 20% to 30% by weight, optionally 35 to 45% by weight of the polymer wax emulsion based on the total weight of the binder. In one embodiment, the binder composition comprises a polymer wax emulsion having a solids content of 40% by weight.

In one embodiment, the fiber-based insulation product comprises at least one base binder, which has a solids content of 20 to 30% by weight, optionally 25% by weight.

In one embodiment, the fiber-based insulation product the nonwoven fiber mat comprises at least 50% of the mineral fibers and/or polymer fibers by weight. In one embodiment, the fiber-based insulation product comprises a nonwoven fiber mat, which comprises 15 to 35% of the binder composition by weight, optionally 28% by weight.

According to one embodiment the binder composition is present in the nonwoven fiber mat in a total amount of 5 to 80% by weight of the total nonwoven fiber mat, optionally 10 to 40% by weight, more optionally 22 to 30% by weight. In one embodiment, the composition may be present in the nonwoven fiber mat in a total amount of 28% by weight of the total nonwoven fiber mat.

Optionally, the binder composition consists essentially of at least one base binder, and at least one polymer wax emulsion, optionally a thermoplastic emulsion, in particular the polymer wax emulsion is based on polyolefin and/or polyurethane or PVC emulsions or PET emulsions or mixtures thereof. The thermoplastic polymer wax emulsion is chemically different from the base binder. Thermoplastic emulsions show a distinct three-dimensional crosslinking compared to polyvinyl or acrylic in solution.

In some embodiments, the polymer wax emulsion is added to the optionally aqueous base binder before the application of the binder onto the nonwoven structure.

As noted, various polymer wax emulsions are commercially available. Examples are Byk Aquacer 1777, Byk Aquacer 1547 as well as the Addcomp products Priex 701, Priex 702 or Priex 703 (polypropylene emulsion). Other examples are PVC emulsions from Solvin NanoVin or styrene-acrylic emulsions from Lubrizol or PE emulsions from Michelman or EASTEK 1200 PET emulsion. Usually, such emulsions comprise additional components such as additives, emulsifiers, stabilizers, etc.

As will be discussed, the addition of the polymer wax emulsion, in particular for emulsions based on polyolefin and/or polyurethane, and/or PVC basis, to the base binder induces multiple benefits and effects. Besides a higher flexibility of the nonwoven fiber mat and less brittleness and dust, fiber-based insulation products made with these nonwoven fiber mats exhibit no or low VOCs and higher resistance when fire retardant additives used as second component. When using other emulsions similar effects can be observed regarding dust and brittleness. A polyolefin based polymer wax emulsion displays an excellent adherence to the insulation core without using further binder saving process steps.

However, in order to ensure the required strengths in the further working of the nonwoven fiber mat, other additional binders can also be introduced and/or known consolidation/mechanical strengthening methods, such as needling, can be used. In addition to the possibility of a mechanical strengthening, e.g. by calendaring or needling, in particular the hydrodynamic needling is also mentioned here. Chemical and/or thermoplastic binders are suitable as binders, as long as they are compatible to the binder composition according to the present disclosure.

### Fiber Mat

The fiber-forming materials for the nonwoven fabric, optionally the cover layer forming the outermost surface, are optionally natural fibers and/or fibers of synthesized or natural polymers, ceramic fibers, mineral fibers, such as glass fibers, that can also be used in the form of mixtures.

The nonwoven fabric can be formed of staple fibers or from filaments, that is, infinitely long fibers.

### Mineral- and Ceramic Fibers

Mineral- and ceramic fibers are optionally aluminosilicate fibers (glass fibers), ceramic fibers, dolomite fibers, wollastonite fibers or fibers of vulcanites, optionally basalt fibers, diabase fibers and/or melaphyr fibers. Diabases and melaphyrs are designated combined as paleobasalts and diabase is also often designated as greenstone. According to one embodiment the average length of the staple fibers in the nonwoven fabric of mineral fibers used is between 8 and 30 mm, optionally 10 to 30 mm. In a further embodiment of the disclosure the nonwoven fabric contains a mixture of endless fibers and staple fibers. The average fiber diameter of the mineral fibers optionally is between 6 and 25 μm, optionally between 8 and 24 μm, and optionally between 8 and 15 μm. The weight per unit area of the nonwoven fabric of mineral fibers optionally is between 15 and 500 g/m², optionally between 30 and 250 g/m², wherein these data refer to a textile structure without any binders, additives or coatings.

### Glass Fibers

In one embodiment, the fiber-based insulation product comprises a nonwoven fiber mat, which comprises glass fibers. Glass fibers for the nonwoven fabrics are particularly suitable. They are constructed from filaments, that is, infinitely long fibers or of staple fibers. In some embodiments, the average length of the staple fibers is between 5 and 90 mm, optionally between 8 to 30 mm. In a further embodiment of the disclosure the glass fiber nonwoven fabric contains a mixture of endless fibers and staple fibers. The mean diameter of the glass fibers optionally is between 5 and 30 μm, optionally between 6 and 25 μm.

In addition to the previously cited diameters so-called glass microfibers can also be used. The average diameter of the glass microfibers may be between 0.1 and 5 μm. The microfibers forming the textile surface can also be present in mixtures with other fibers, optionally glass fibers. Moreover, a layer-shaped construction of microfibers and glass fibers is also possible.

In a further embodiment, the nonwoven fabric can also additionally have a reinforcement of fibers, threads or filaments. Reinforcement threads are optionally multi-filaments or rovings based on glass, polyester, carbon or metal. The reinforcement threads can be used as such or also in the form of a textile surface structure, e.g., as fabric, laying, knitted fabric, knitwear or nonwoven fabric or scrims. The reinforcements optionally consist of a parallel thread sheet or of a laying.

The weight per unit area of the nonwoven fabric of glass fibers optionally is between 15 and 500 g/m², optionally between 40 and 250 g/m², wherein the data refers to a surface structure without any binders, additives or coatings. Suitable glass fibers comprise, among others, those manufactured from A-glass, C-glass, Eglass, S-glass, T-glass or R-glass.

In some embodiments, the nonwoven fabric comprises glass or polymer fibers or a mixture thereof, optionally glass fibers. The nonwoven fabric may include glass fibers having a mean diameter between 6 and 25 μm and optionally a length between 8 and 30 mm. The nonwoven fiber mat may have a thickness between 0.1 and 10 mm, optionally between 0.2 and 0.6 mm. In a further embodiment an average weight is between 10 and 300 g/sqm, optionally between 20 and 150 g/sqm.

The nonwoven fabric may include mineral fibers such as C-glass fibers, E-glass fibers, S-glass fibers, T-glass fibers, aluminosilicate fibers, ceramic fibers, dolomite fibers, wollastonite fibers or fibers of vulcanites, optionally basalt fibers, diabase fibers, melaphyr fibers, more optionally basalt fibers or a combination thereof, optionally C-glass, E-glass, S-Glass, T-Glass or a mixture thereof.

### Polymer Fibers

Among the nonwoven fabric of fibers of synthetic polymers, nonwoven fabrics, especially so-called spunbonds, that is, spunbonded nonwoven fabrics produced by a tangled deposit of melt-spun filaments are suitable, for instance, if they consist of endless synthetic fibers of melt-spinnable polymer materials. Suitable polymer materials are, e.g., polyamides such as, e.g., polyhexamethylene diadipamide, polycaprolactam, aromatic or partially aromatic polyamides (“aramids”), aliphatic polyamides such as, e.g., nylon, partially aromatic or fully aromatic polyesters, polyphenylene sulfide (PPS), polymers with ether- and keto groups such as, e.g., polyetherketones (PEK) and polyetheretherketone (PEEK), polyolefins such as, e.g., polyethylene or polypropylene, cellulose or polybenzimidazoles. In addition to or alternatively to the previously cited synthetic polymers, those polymers are also suited that are spun from solution.

The spunbonded nonwoven fabrics optionally consist of melt-spinnable polyesters. In principle, all known types of polyester material suitable for the manufacture of fibers are considered as polyester material. Polyesters containing at least 95 mole % polyethyleneterephthalate (PET), especially those of unmodified PET, are especially suitable. When calandered, spunbond materials are made, and a spray gun and infrared dryer may be installed.

If the composite materials in accordance with the disclosure should additionally have a flame-retardant action, it is advantageous if they were spun from polyesters modified in a flame-retardant manner. Such polyesters modified in a flame-retardant manner are known. The individual titers of the polyester filaments in the spunbonded nonwoven fabric optionally are between 1 and 16 dtex, optionally between 2 to 10 dtex.

In a further embodiment of the disclosure the spunbonded nonwoven fabric can also be a bonded fiber fabric hardened by melt binder and optionally which contains carrier fibers and/or melded fibers. The carrier fibers and melded fibers can be derived from any thermoplastic, fiber forming polymers. Such spunbonded nonwoven fabrics hardened by melt binder are described, e.g., in EP 0 446 822 A1 and EP 0 590 629 A1. In addition to endless filaments (spun-bond method) the textile nonwoven surface can also be constructed of staple fibers or mixtures of staple fibers and endless filaments. The individual titers of the staple fibers in the nonwoven fabric optionally are between 1 and 16 dtex, optionally between 2 to 10 dtex. The staple length optionally is 1 to 100 mm, optionally 2 to 500 mm, and optionally 2 to 30 mm. The nonwoven fabric can also be constructed of fibers of different materials in order to be able to achieve special properties.

The nonwoven fabric can also additionally have a reinforcement of fibers, threads or filaments. Multi-filaments or rovings based on glass, polyester, carbon or metal, or a combination thereof, are suitable as reinforcement threads. The reinforcement threads can be used as such or also in the form of a textile surface structure, e.g., as fabric, laying, knitted fabric, knitwear or nonwoven fabric. The reinforcements optionally consist of a parallel thread sheet or a laying.

The filaments and/or staple fibers constructing the bonded fiber fabric can have a practically round cross-section or also other forms such as dumbbell-shaped, kidney-shaped, triangular or tri- or multi-lobed cross-sections. Hollow fibers and bi- or multi component fibers can also be used. Furthermore, the melded fibers can also be used in the form of bi-component or multicomponent fibers.

The fibers forming the nonwoven fabric can be modified by customary additives, e.g., by antistatic agents such as carbon black.

The weight per unit area of the nonwoven fabric of fibers of synthetic polymers optionally is between 10 and 500 g/m², optionally between 20 and 250 g/m², wherein the data refers to a surface structure without any binders, additives or coatings.

### Natural Polymer Fibers

The natural fibers are vegetable fibers, e.g., fibers derived from grasses, straw, wood, bamboo, reed and bast, or fibers of animal origin. Plant fibers are a collective concept and stands for seed fibers such as cotton, kapok or poplar fluff, bast fibers such as bamboo fiber, hemp, jute, linen or ramie, hart fibers such as sisal or manila, or fruit fibers such as coconut. Fibers of animal origin are wools, animal hairs, feathers and silks. The weight per unit area of the nonwoven fabric of natural fibers optionally is between 20 and 500 g/m², optionally between 40 and 250 g/m², where the data refers to a surface structure without any binders, additives or coatings.

The textile surfaces of fibers of natural polymers optionally are cellulose fibers such as viscose or vegetable or animal protein fibers. Among the textile surfaces of cellulose fibers nonwoven fabrics are suitable. They are constructed from filaments, that is, infinitely long fibers and/or from staple fibers. The average length of the staple fibers optionally is between 1 and 25 mm, optionally 2 to 5 mm. The average diameter of the cellulose fibers optionally is between 5 and 50 μm, optionally between 15 and 30 μm.

### Binder Application

The application of the binder composition according to the present disclosure onto the nonwoven fibers can take place with the aid of all known methods. In addition to or alternatively to spraying on, impregnating and pressing in, the binder can also be applied by coating or by rotary nozzle heads. If following the inline process path binder composition according to the present disclosure can also be part of the white water or any other aqueous means used for the production of the nonwoven layer.

A further method is the application of the new binder composition according to the present disclosure by the application of foam. In the application of foam binder, foam is produced with the aid of a foaming agent in a foam mixer that is applied by suitable coating aggregates onto the nonwoven fabric. The application can also take place here by rotary nozzle heads. In the foam coating binder composition there are basically no limitations regarding the foaming agent. Some foaming agents are ammonium stearates or succinic acid esters added with 1 to 5% by weight in dry mass to the binder. Furthermore, the already described catalysts are mixed in if required. The solids content of the foam optionally is at least 40%, optionally at least 50%.

The total binder content in the nonwoven fabric optionally is between 10 and 80% based on total weight of the dried surface structure and includes all applied binder components and additives.

### Functional Materials

In one embodiment, the fiber-based insulation product comprises a binder composition, which comprises corrosion inhibitors, crosslinking density enhancers, biocides, or a combination thereof.

The composite material comprising the binder composition can contain additives and/or functional materials. The additives and functional material can be applied at the same time with the binder composition, e.g., as mixture or as individual components, or before or after the application of the binder composition. In as far as the binder composition is applied by foam application it is advantageous to apply the functional material with the foam or distributed in the foam or to apply the functional material onto the still fresh foam.

In order to fix the functional materials a binder can be additionally added for fixing the functional materials on the nonwoven fabric. The content of functional material is determined by the subsequent use.

The application of the functional material used takes place as a function of the nature of the particular functional material by known techniques. The application can also take place by rotary nozzle heads.

The functional material is optionally flame proofing agents, materials for discharging electrostatic charges, materials for screening off electromagnetic rays, organic or inorganic pigments, especially colored pigments, materials that increase the resistance to wear and/or slippage. The functional materials are optionally arranged on the side of the nonwoven fabric and can at least partially pass through the nonwoven fabric.

In a variant of the method an additional binder is added to fix the functional materials on the nonwoven layer. The same binder (B-stage binder) as is present in the nonwoven layer is optionally selected here. The content of functional materials is determined by the subsequent use.

### Flame Proofing Agents

In some embodiments, the flame proofing agents are inorganic flame proofing agents, organophosphorus flame proofing agents, nitrogen-based flame proofing agents or intumescences flame proofing agents. Halogenated (brominated and chlorinated) flame proofing agents can also be used but are less desirable on account of their risk evaluation. Examples for such halogenated flame proofing agents are polybrominated diphenylether, e.g., decaBDE, tetrabromobisphenol A and HBCD (hexabromocyclododecane). The nitrogen-based flame proofing agents optionally are melamines and urea.

The organophosphorus flame proofing agents are typically aromatic and alkyl esters of phosphoric acid. TCEP (trischloroethylphosphate), TCCP (trischloropropylphosphate), TDCCP (trisdichloroisopropylphosphate), triphenylphosphate, trioctylphosphate (tris-(2-ethylhexyl) phosphate) are optionally used.

The inorganic flame proofing agents are typically hydroxides such as aluminum hydroxide and magnesium hydroxide, borates such as zinc borate, ammonium compounds such as ammonium sulfate, red phosphorus, antimony oxides such as antimony trioxide and antimony pentoxide and/or laminated silicates such as vermiculite. In addition, some agents include expandable graphite.

### Antistatic Agents

Antistatic and electromagnetic screening effects can be achieved by the use of agents for raising the electrical conductivity.

The antistatic agents are usually particles that are electrically conductive. Suitable materials are electrically conductive carbons such as carbon black, graphite and carbon nanotubes (C-nanotubes), conductive plastics or fibers of metal or metallic components.

The materials for screening electromagnetic rays are usually electrically conductive materials. They can be built up in the form of foils, particles, fibers or wires and/or textiles surface structures of the previously cited materials.

### Fillers

Fillers are materials such as CaCO₃, coated CaCO₃, coated or uncoated Kaolin, talcum, gypsum or silica, etc., and optionally can be used as components of the binder composition.

### Pigments

The inorganic or organic pigments are particulate materials. In addition to fillers such as CaCO₃, talcum, gypsum or silica, the pigments, to the extent that they should increase the value of the composite material, are in particular pigments that can be used in colors.

### Hydrophobic Agents

Hydrophobic agents are additives which are able to increase or modify the compatibility of the Bstage binder composition to the carrier or the nonwoven fabric. According to one embodiment of the fiber-based insulation product prominent but not limiting examples are fluorine or silane containing components which can greatly improve the compatibility of the binder to metal and glass surfaces.

### Insulation Core

In one embodiment, the insulation material is a mineral fiber-based insulation product, in another embodiment it comprises a polyurethane foam core, other chemical compatible foams, or a combination thereof. These insulation cores typically consist of a core polymeric foamed thermoset material, such as polyurethane, polyisocyanurate, or phenolic resin, or the like. Also, the use of polystyrene foam (expanded Polystyrene (EPS) or extruded Polystyrene (XPS)), polyisocyanurate (PIR) foam, phenolic foam, melamine foam or spray foam is conceivable. Additional to or alternatively to the foamed products described, wool products, optionally mineral wool materials, are used as insulation material for the insulation core layer.

### Method of Manufacturing a Semi-Finished Composite Material

Another Subject Matter of the Present Disclosure is a Method for the Manufacture of a Semifinished Composite Material Comprising the Measures:
a) Supplying of a nonwoven fabric, whereas the nonwoven fabric optionally has received a pre-strengthening,
b) Application of at least one binder composition comprising at least one base binder and at least one polymer wax emulsion, optionally a thermoplastic emulsion, in particular the emulsion is based on polyolefin and/or polyurethane or PVC emulsions or PET,
c) Optionally applying at least one functional material to the nonwoven fabric according to b),
d) Drying the nonwoven fabric.

The nonwoven fabric in measure a) has an additional pre-strengthening treatment as already described above. However, it is also possible to apply the binder composition according to the present disclosure to the nonwoven fabric during its formation. In this so-called in-line process measures steps a) and b) are carried out simultaneously at the same time during the formation of the nonwoven fabric. The inline process does not necessarily require pre-strengthening means if the base binder composition itself can provide sufficient binding strength.

The application of the binder in step b) can be accomplished as described above. Optionally, functional materials can be applied. The functional materials can be applied together with the binder or after the application of the binder. The subsequent drying step d) removes the water and cures the base binder.

The temperature and duration of the drying step d) depends on the materials used, the process, and the planned applications. It is particularly important to set the temperature and drying duration according to the required degree of curing binder composition. E.g. a polyolefin binder cures at 150 °C and the base binder at 200 °C.

The process results in a semi-finished product, comprising a nonwoven, binder composition according to the present disclosure, and optionally functional materials. In particular the semi-finished product can be used for the manufacturing of a fiber-based insulation product.

### Methods of Manufacturing Composites

Another subject matter of the present disclosure is a method for manufacturing a fiber-based insulation product, wherein the method comprises the steps of
a) providing
i. mineral fibers in an aqueous fiber slurry in a wet laid process onto a transport belt or
ii. providing PET fibers or mixtures of PET fibers with mineral fibers in an aqueous fiber slurry in a wet laid process onto a transport belt,
b) removing white water at least partly,
c) applying a thermoplastic binder composition comprising at least one aqueous thermoplastic binder and 25 to 75% by weight of at least one polymer wax emulsion based on the total weight of the binder,
d) drying the resulting glass fiber nonwoven,
e) laminating an insulation core layer to the glass fiber nonwoven at a temperature of between 100 to 250 °C at a pressure of between 1 and 40 bar.

In some embodiments, the thermoplastic binder composition in step c) is applied by curtain coating or sprayed on one side. In an example manufacturing process, the binder composition is applied during manufacturing of the composite whereas one oven heat consolidation (the adhesion process being combined with the new binder consolidation) can be saved. Alternatively, nonwoven fiber mat and insulation core are adhered by heat pressing. Also, according to the alternative method no oven consolidation is required as the binder can solely locally be remelted via e.g. a heated roll and pressed onto the insulation core for adherence.

A streamlined manufacturing process by combining the adhesion process with the binder consolidation, potentially eliminating the need for separate oven consolidation steps, leads to cost savings and reduced manufacturing complexity.

Another subject matter of the present disclosure is a method for manufacturing a fiber-based insulation product, wherein the method comprises the steps of a) applying a binder composition to mineral fibers and/or polymer fibers, wherein the binder composition comprises
i. at least one polymer wax emulsion and
ii. at least one base binder of polyvinyl alcohol, polyacrylate, or polyvinyl acetate, or a combination thereof,
b) curing or drying of the resulting nonwoven fiber mat,
c) adhering the nonwoven fiber mat to an insulation core layer
i. by at least locally remelting the binder composition and
ii. pressing the nonwoven fiber mat onto the insulation core layer.

In some embodiments, the nonwoven fiber mat is manufactured by applying the binder composition to glass fibers, followed by curing or drying, optionally at a temperature of 160 to 230 °C, optionally 210 to 220 °C, to form a bonded mat structure. The binder composition can be applied using techniques such as curtain coating, spraying, or other conventional methods.

According to another embodiment, the fiber-based insulation product comprises a core layer, which is adhered to the nonwoven fiber mat by at least locally remelted binder composition. The nonwoven fiber mat particularly can be adhered to an insulation core layer by heat pressing, where the binder composition is locally remelted and pressed onto the insulation core layer, optionally at a temperature of 180 °C. Optionally, the pressing takes place under a pressure of 100 N/cm². This process eliminates the need for separate oven consolidation steps, streamlining the manufacturing process.

In one embodiment, the nonwoven fiber mat, especially according to the aforementioned step c) ii. (Adhering the nonwoven fiber mat), is pressed onto the core layer using pressure of 1 to 400 10 N/cm², optionally 50 to 200 N/cm², optionally 100 N/cm². In one embodiment, the nonwoven fiber mat, especially according to the aforementioned step c) ii. (Adhering the nonwoven fiber mat), is pressed onto the core layer at a temperature of 100 to 250 °C, optionally of 150 to 230 °C, optionally 180 °C.

### EXAMPLES

### Example 12

A nonwoven glass fiber mat comprising the binder composition of the present disclosure was prepared as follows. A blend of chopped ECR (E-Glass Corrosion Resistant) glass fibers, comprising 70% of 18 mm long and 13 μm diameter fibers and 30% of 10 mm long and 10 μm diameter fibers, were formed into a web of randomly oriented fibers using a wet-laid process. A binder composition comprising (i) a polymer wax emulsion of a polypropylene emulsion having a solids content of 40% by weight, and (ii) a base binder of polyvinyl alcohol having a solids content of 20% by weight, was applied to the web by a curtain coater. The weight ratio of the polypropylene emulsion to the polyvinyl alcohol was 2:1. The binder composition was cured using an oven at a temperature of 220 °C for 15 seconds. The resulting nonwoven fiber mat had a basis weight of 0.02 lb/ft² (100 gsm) and contained about 25% by weight solids of the binder composition based on the total weight of the nonwoven fiber mat.

### Example 13

A nonwoven glass fiber mat comprising the binder composition of the present disclosure was prepared as follows. A blend of chopped ECR glass fibers, comprising 60% of 16 mm long and 11 μm diameter fibers and 40% of 8 mm long and 9 μm diameter fibers, were formed into a web of randomly oriented fibers using an air-laid process. A binder composition comprising (i) a polymer wax emulsion of a polyurethane emulsion having a solids content of 35% by weight, and (ii) a base binder of polyacrylate having a solids content of 25% by weight, was applied to the web by spraying. The weight ratio of the polyurethane emulsion to the polyacrylate was 1.5:1. The binder composition was cured using an oven at a temperature of 210 °C for 20 seconds.

The resulting nonwoven fiber mat had a basis weight of 0,018 lb/ft² (90 gsm) and contained about 22% by weight solids of the binder composition based on the total weight of the nonwoven fiber mat.

### Example 14

A nonwoven glass fiber mat comprising the binder composition of the present disclosure was prepared as follows. A blend of chopped ECR glass fibers, comprising 65% of 20 mm long and 14 μm diameter fibers and 35% of 12 mm long and 11 μm diameter fibers, were formed into a 10 web of randomly oriented fibers using a wet-laid process. A binder composition comprising (i) a polymer wax emulsion of a polyvinyl chloride emulsion having a solids content of 45% by weight, and (ii) a base binder of polyvinyl acetate having a solids content of 30% by weight, was applied to the web by a curtain coater. The weight ratio of the polyvinyl chloride emulsion to the polyvinyl acetate was 1.8:1. The binder composition was cured using an oven at a temperature of 230 °C for 18 seconds. The resulting nonwoven fiber mat had a basis weight of 0,024 lb/ft² (120 gsm) and contained about 28% by weight solids of the binder composition based on the total weight of the nonwoven fiber mat.

### Example 15

An example of the disclosure is a fiber-based insulation product comprising 30% thermoplastic binder and 70% glass fiber, optionally in addition to an aluminum foil (percentages without the weight of the aluminum foil). The binder was a mixture of PP and an acrylic system. A press temperature of 180 °C at a pressure of 100 N/cm² at a pressure time of 90 seconds may be used.

Table 1 above shows examples of different binder compositions used in the context of a product according to the disclosure.

According to Examples 1-5 and Examples 12-15 of the exemplary embodiments in Table 1 an anionic emulsion of an oxidized HDPE wax (Aquacer® 1547) was dispersed in water and applied to the glass staple fiber web. Aquacer® 1547 sold by BYK-Chemie GmbH is a HDPE-based wax emulsion, namely an anionic emulsion of an oxidized HD polyethylene wax. The non-volatile matter content at (60 min., 125 °C) is 35% by weight. It forms a dispersion in water. The melting point of the wax content is 125 °C and the viscosity is 40 15 mPa·s at 23 °C and a stirring rate of D=400/s. The pH value is 9.7. Examples 1-5 and 12-15 are comparative examples as the binder composition only comprises a polymer wax emulsion but no additional binder component.

According to Example 6 to Example 11 of the exemplary embodiments in Table 1 the 20 HDPE wax emulsion (Aquacer® 1547) was mixed with an aqueous polyvinyl acetate emulsion (Mowolith® DN 60) in different ratios and applied to the glass staple fiber web. Mowilith® DN 60 is an aqueous polymer dispersion based on vinyl acetate and stabilized by polyvinyl alcohol sold by Celanese Sales Germany GmbH. Mowolith® DN 60 has a solids content at (130 °C; 30 min-ISO 3251) of between 59-61%. It has a Brookfield 25 viscosity at (25 °C; 6/20-ISO 2555) of between 10000-18000 mPa·s. The pH value is between 4.0 to 6.0 in a 1:1 water dilution. It has a glass transition temperature according to ISO 16805 of approx. 38 °C.

The glass fibers nonwoven comprised between 80% and 100% of E-glass fibers having an average diameter of 12.5 μm and a length of 18 mm and between 20% and 0% of E-glass fibers having an average diameter of 11 μm and a length of 12 mm. Non woven fiber webs or mats with an area weight of between 40.5 g/m² to 152 g/m² were produced.

Specific details are given in the description to provide a thorough understanding of the embodiments. However, it will be understood by one of ordinary skill in the art that the embodiments may be practiced without these specific details. For example, well-known materials and techniques have been shown without unnecessary detail in order to avoid obscuring the embodiments. This description provides example embodiments only, and is not intended to limit the scope, applicability, or configuration of the disclosure. Rather, the preceding description of the embodiments will provide those skilled in the art with an enabling description for implementing embodiments of the disclosure. Various changes may be made in the function and arrangement of elements without departing from the spirit and scope of the disclosure.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASMER) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A cover layer comprising at least one nonwoven fiber mat, comprising mineral fibers and/or polymer fibers and a binder composition, wherein the binder composition comprises
(i) at least one polymer wax emulsion and
(ii) at least one base binder of polyvinyl alcohol, polyacrylate, or polyvinyl acetate, or a combination thereof.

2. The fiber-based insulation product according to claim 1, further comprising:
at least one core layer comprising an insulation material, and at least one cover layer forming the outermost surface, comprising at least one nonwoven fiber mat, comprising mineral fibers and/or polymer fibers and a binder composition,
wherein the binder composition comprises (i) at least one polymer wax emulsion and (ii) at least one base binder of polyvinyl alcohol, polyacrylate, or polyvinyl acetate, or a combination thereof.

3. The fiber-based insulation product according to claim 2, wherein the binder further comprises a carbohydrate binder component selected from monosaccharide, disaccharide, trisaccharides, tetrasacharides, pentasaccharides and/or reaction products thereof, or a combination thereof.

4. The fiber-based insulation product according to claim 2, wherein the at least one polymer wax emulsion is a thermoplastic emulsion.

5. The fiber-based insulation product according to claim 4, wherein the thermoplastic emulsion is based on polyolefin, polyurethane (PU), polyvinyl chloride (PVC), polyethylene terephthalate (PET), or a combination thereof.

6. The fiber-based insulation product according to claim 5, wherein the polyolefin is polypropylene (PP), polyethylene (PE), or a combination thereof.

7. The fiber-based insulation product according to claim 2, wherein the at least one base polymer wax emulsion is colored by black pigments.

8. The fiber-based insulation product according to claim 2, wherein the at least one polymer wax emulsion has a solids content of 25 to 55% by weight, optionally 40% by weight.

9. The fiber-based insulation product according to claim 2, wherein the at least one base binder has a solids content of 20 to 30% by weight, optionally 25% by weight.

10. The fiber-based insulation product according to claim 2, wherein the binder composition further comprises corrosion inhibitors, crosslinking density enhancers, biocides, or a combination thereof.

11. The fiber-based insulation product according to claim 2, wherein the nonwoven fiber mat comprises at least 50% of the mineral fibers and/or polymer fibers by weight.

12. The fiber-based insulation product according to claim 2, wherein the nonwoven fiber mat comprises glass fibers.

13. The fiber-based insulation product according to claim 2, wherein the nonwoven fiber mat comprises 15 to 35% of the binder composition by weight, optionally 28% by weight.

14. The fiber-based insulation product according to claim 2, wherein the insulation material comprises a polyurethane foam and/or a wool material.

15. The fiber-based insulation product according to claim 2, wherein the core layer is adhered to the nonwoven fiber mat by at least locally remelted binder composition.

16. A method for manufacturing a fiber-based insulation product, comprising:
a) applying a binder composition to mineral fibers and/or polymer fibers, whereby the binder comprises (i) at least one polymer wax emulsion and (ii) at least one base binder of polyvinyl alcohol, polyacrylate, or polyvinyl acetate, or a combination thereof,
b) curing or drying of the resulting nonwoven fiber mat,
c) adhering the nonwoven fiber mat to a core layer
i. by at least locally remelting the binder composition and
ii. pressing the nonwoven fiber mat onto the core layer.

17. The method according to claim 16, wherein the binder composition in step 5 a) is applied by curtain coating or sprayed.

18. The method according to claim 16, wherein the nonwoven fiber mat in step b) is cured at a temperature of 160 to 230 °C, optionally 210 to 220 °C.

19. The method according to claim 16, wherein the nonwoven fiber mat in step c) ii. is pressed onto the core layer at a temperature of 100 to 250 °C, optionally 150 to 230 °C, optionally 180 °C.

20. The method according to claim 16, wherein the nonwoven fiber mat in step c) ii. is pressed onto the core layer using a pressure of 1 to 400 N/cm², optionally 50 to 200 N/cm², optionally 100 N/cm².
